(19) United States
(12) Patent Application Publication
(10) Pub. No.: US 2023/0335870 A1
(43) Pub. Date: Oct. 19, 2023

(54) DETECTION AND MITIGATION OF THERMAL RUNAWAY PROPAGATION IN A VEHICLE BATTERY

(71) Applicant: GM Global Technology Operations LLC, Detroit, MI (US)

(72) Inventors: Venkata Prasad Atluri, Novi, MI (US); Jeremie Dernotte, Shelby Township, MI (US); Suresh Gopalakrishnan, Troy, MI (US); Chandra S. Namuduri, Troy, MI (US)

(21) Appl. No.: 17/721,536

(22) Filed: Apr. 15, 2022

(51) Int. Cl. H01M 50/581; B60L 58/10; H01M 10/48

(52) U.S. Cl. CPC H01M 50/581; B60L 58/10; H01M 10/486; B60L 2240/36; H01M 2200/10; H01M 2200/20; H01M 2220/20

(57) ABSTRACT

A system in a vehicle includes two or more modules. Each of the two or more modules includes battery cell groups. The battery cell groups of the two or more modules provide propulsion power for the vehicle. The two or more modules also include a voltage sensor to measure a voltage output by the battery cell groups of the module, a temperature sensor arranged to measure a temperature within the module, a gas sensor arranged to sense a hydrogen level within the module, and an infrared sensor positioned to obtain an infrared radiation profile within the module. The system also includes two or more relays, one of the two or more relays being arranged to electrically isolate one of the two or more modules based on the voltage, the temperature, the hydrogen level, or the infrared radiation profile for the one of the two or more modules.

### INTRODUCTION

The subject disclosure relates to detection and mitigation of thermal runaway propagation in a vehicle battery.

A vehicle battery includes a number (e.g., hundreds) of individual cells arranged in series or parallel. A subset of cells may be grouped as a module and a set of modules may be grouped as a pack, for example. Each module may include a cell monitoring unit while a battery management system monitors the state of a pack. Thermal runaway propagation refers to heat buildup in a cell (e.g., due to a short or other internal issue) that is dissipated to surrounding cells of the module and to other modules. This chain reaction may lead to battery damage and may potentially create a safety hazard. Accordingly, it is desirable to provide detection and mitigation of thermal runaway propagation in a vehicle battery.

### SUMMARY

In one exemplary embodiment, a system in a vehicle includes two or more modules. Each of the two or more modules includes battery cell groups. The battery cell groups of the two or more modules provide propulsion power for the vehicle. The two or more modules also include a voltage sensor to measure a voltage output by the battery cell groups of the module, a temperature sensor arranged to measure a temperature within the module, a gas sensor arranged to sense a hydrogen level within the module, and an infrared sensor positioned to obtain an infrared radiation profile within the module. The system also includes two or more relays, one of the two or more relays being arranged to electrically isolate one of the two or more modules based on one or more of the voltage, the temperature, the hydrogen level, and the infrared radiation profile for the one of the two or more modules.

In addition to one or more of the features described herein, the system also includes a cell monitoring unit corresponding with each of the two or more modules.

In addition to one or more of the features described herein, the one of the two or more relays is controlled by the cell monitoring unit corresponding with the one of the two or more modules.

In addition to one or more of the features described herein, the system also includes a battery management system to obtain the voltage, the temperature, the hydrogen level, and the infrared radiation profile for each of the two or more modules.

In addition to one or more of the features described herein, the one of the two or more relays is controlled by the battery management system.

In addition to one or more of the features described herein, the system also includes a cloud-based controller to obtain the voltage, the temperature, the hydrogen level, and the infrared radiation profile for each of the two or more modules.

In addition to one or more of the features described herein, the one of the two or more relays is controlled based on one or more algorithms implemented by the cloud-based controller.

In addition to one or more of the features described herein, the system also includes a cell monitoring unit corresponding with each of the two or more modules and a battery management system coupled to each cell monitoring unit. Each cell monitoring unit obtains the voltage, the temperature, the hydrogen level, and the infrared radiation profile for the corresponding module and provides the voltage, the temperature, the hydrogen level, and the infrared radiation profile to the battery management system. The battery management system characterizes a current state of each of the two or more modules based on one or more of the voltage, the temperature, the hydrogen level, and the infrared radiation profile from each cell monitoring unit.

In addition to one or more of the features described herein, the current state is represented as a level and is determined by comparing each of the voltage, the temperature, and the hydrogen level to predefined threshold values and by comparing a dissimilarity score obtained from the infrared radiation profile with a predefined threshold dissimilarity score.

In addition to one or more of the features described herein, the battery management system maps the current state of each of the two or more modules to an action. The action includes control of the two or more relays.

In another exemplary embodiment, a method of assembling a system in a vehicle includes assembling two or more modules to include battery cell groups. The battery cell groups of the two or more modules provide propulsion power for the vehicle. The two or more modules also include a voltage sensor to measure a voltage output by the battery cell groups of the module, a temperature sensor arranged to measure a temperature within the module, a gas sensor arranged to sense a hydrogen level within the module, and an infrared sensor positioned to obtain an infrared radiation profile within the module. The method also includes arranging two or more relays, one of the two or more relays being arranged to electrically isolate one of the two or more modules based on the voltage, the temperature, the hydrogen level, or the infrared radiation profile for the one of the two or more modules.

In addition to one or more of the features described herein, the method also includes coupling a cell monitoring unit to each of the two or more modules.

In addition to one or more of the features described herein, the method also includes configuring the cell monitoring unit corresponding with the one of the two or more modules to control the one of the two or more relays.

In addition to one or more of the features described herein, the method also includes arranging a battery management system to obtain the voltage, the temperature, the hydrogen level, and the infrared radiation profile for each of the two or more modules.

In addition to one or more of the features described herein, the method also includes configuring the battery management system to control the one of the two or more relays.

In addition to one or more of the features described herein, the method also includes establishing communication with a cloud-based controller such that the cloud-based controller obtains the voltage, the temperature, the hydrogen level, and the infrared radiation profile for each of the two or more modules.

In addition to one or more of the features described herein, the method also includes implementing one or more algorithms at the cloud-based controller to control the one of the two or more relays.

In addition to one or more of the features described herein, the method also includes coupling a cell monitoring unit to each of the two or more modules and to a battery management system, configuring each cell monitoring unit to obtain the voltage, the temperature, the hydrogen level, and the infrared radiation profile for the corresponding module and to provide the voltage, the temperature, the hydrogen level, and the infrared radiation profile to the battery management system, and configuring the battery management system to characterize a current state of each of the two or more modules based on the voltage, the temperature, the hydrogen level, or the infrared radiation profile from each cell monitoring unit.

In addition to one or more of the features described herein, the configuring the battery management system includes the battery management system characterizing the current state as a level comparing each of the voltage, the temperature, and the hydrogen level to predefined threshold values and by comparing a dissimilarity score obtained from the infrared radiation profile with a predefined threshold dissimilarity score.

In addition to one or more of the features described herein, the configuring the battery management system includes the battery management system mapping the current state of each of the two or more modules to an action, wherein the action includes control of the two or more relays.

The above features and advantages, and other features and advantages of the disclosure are readily apparent from the following detailed description when taken in connection with the accompanying drawings.

### BRIEF DES CRIPTION OF THE DRAWINGS

Other features, advantages and details appear, by way of example only, in the following detailed description, the detailed description referring to the drawings in which:

FIG. 1 is a block diagram of a vehicle in which detection and mitigation of thermal runaway propagation in the battery is implemented according to one or more embodiments;

FIG. 2 details aspects of an exemplary battery system of a vehicle that implements detection and mitigation of thermal runaway propagation according to one or more embodiments; and

FIG. 3 is a process flow of a method of implementing detection and mitigation of thermal runaway propagation according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, thermal runaway propagation refers to heat energy release in a battery cell that is proliferated to other cells. Prior approaches to detecting the conditions that may give rise to thermal runaway propagation include monitoring temperature and voltage at the cell level. However, these parameters tend to indicate the effects of heat release rather than acting as predictors of such an event. Embodiments of the systems and methods detailed herein relate to detection and mitigation of thermal runaway propagation in a vehicle battery. A gas sensor and infrared sensor are used to obtain parameters, additional to temperature and voltage, that help detect an impending heat release. In addition, active relays are used to isolate the module with the faulty cell, thereby preventing the propagation of the thermal event.

One or more gas sensors and infrared (IR) sensors may be arranged to monitor the cells of a module in addition to the temperature and voltage sensors, for example. While a module and pack are discussed as exemplary hierarchical arrangements for cells, alternate or additional groupings of battery cells are contemplated according to alternate embodiments. The gas sensor and infrared sensor, in addition to the relays, would protect one or more groups of cells from a group of cells in which at least one cell experiences a thermal event. In addition, two or more modules may be isolated from other modules to prevent thermal propagation.

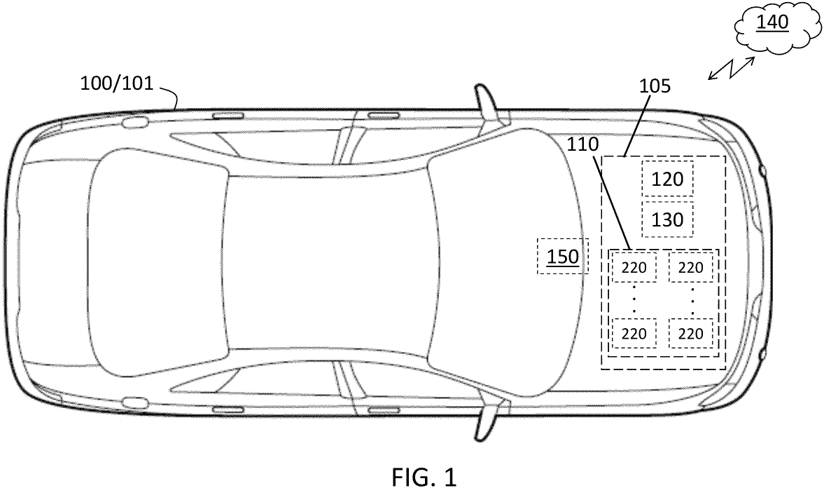

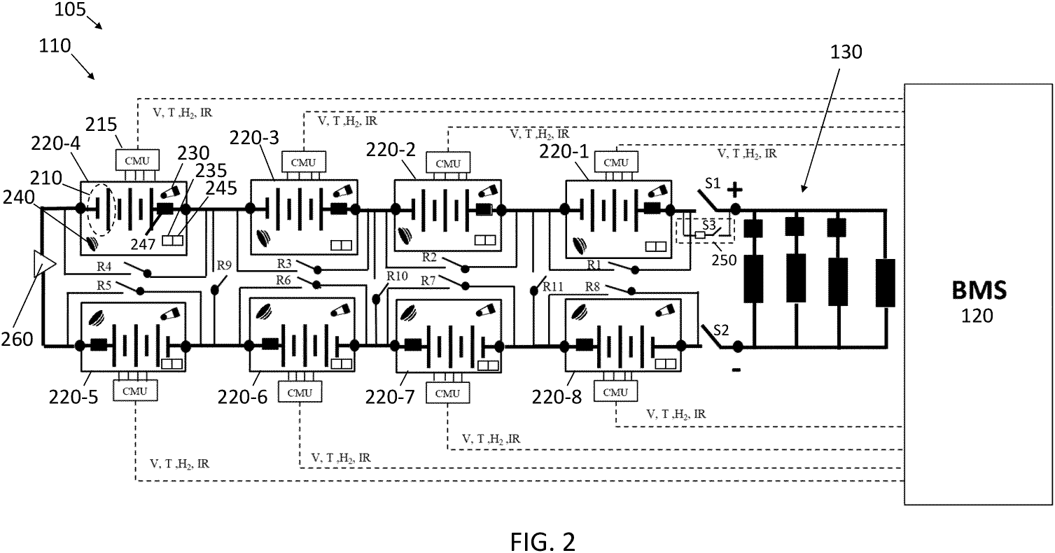

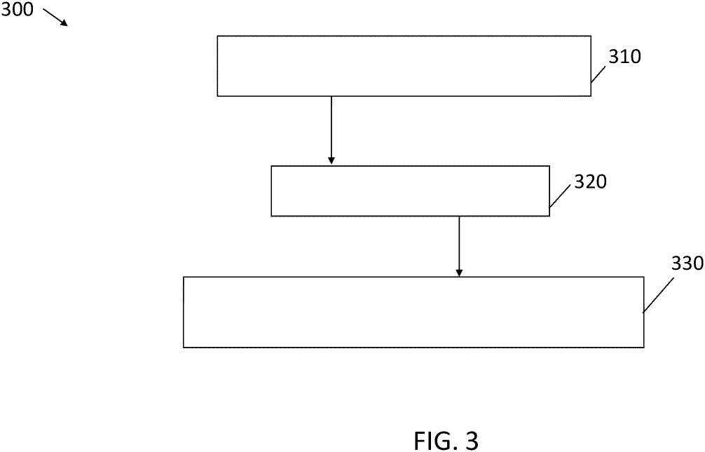

In accordance with an exemplary embodiment, FIG. 1 is a block diagram of a vehicle 100 in which detection and mitigation of thermal runaway propagation in the battery is implemented. The exemplary vehicle 100 shown in FIG. 1 is an automobile 101. A propulsion system 105 is indicated and is further detailed in FIG. 2. A battery pack 110 is shown to include a number of modules 220. Each of the modules includes a number of cells 210 and an associated cell monitoring unit (CMU) 215 (FIG. 2). A battery management system (BMS) 120 and other components 130 (e.g., inverters) are also part of the propulsion system 105. Vehicle 100 may include one or more controllers to control aspects of the operation of the vehicle 100. In addition, the BMS 120 or other controllers of the vehicle 100 may communicate with a cloud-based controller 140. The cloud-based controller 140 may implement algorithms that predict a likelihood of thermal runaway propagation based on information communicated from the BMS 120 or other controllers 150 of the vehicle 100. The cloud-based controller 140 may additionally or alternately use the information to characterize the modules 220, as discussed with reference to FIG. 3.

FIG. 2 details aspects of an exemplary propulsion system 105 of a vehicle 100 that implements detection and mitigation of thermal runaway propagation according to one or more embodiments. Modules 220-1 through 220-8 (generally referred to as module 220) are indicated. In FIG. 2, one cell group 210, CMU 215, infrared sensor 230, temperature sensor 235, gas sensor 240, voltage sensor 245, and internal disconnect switch 247 (i.e., those associated with module 220-4) are labeled for readability. However, it should be understood from FIG. 2 that each of the exemplary modules 220 includes an associated CMU 215, infrared sensor 230, temperature sensor 235, gas sensor 240, voltage sensor 245, and internal disconnect switch 247, as well as three cell groups 210 in series. A cell group 210 represents one cell or two or more cells that are arranged in parallel or in series.

Also, while one of each type of sensor 230, 235, 240, 245 is shown in each module 220 for explanatory purposes, the numbers and locations of the sensors 230, 235, 240, 245 within the modules 220 are only exemplary. For example, the voltage sensor 245 would likely be electrically coupled to the cell groups 210. As another example, multiple gas sensors 240 and temperature sensors 235 may be arranged in different areas of each module 220 for higher resolution in the information obtained. Further, although three cell groups 210 are shown in the exemplary illustration, each module 220 many include any number of cell groups 210.

The CMU 215 associated with each module 220 collects the voltage V from the voltage sensor 245, the temperature T from the temperature sensor 235, the hydrogen level H₂ (e.g., in parts per million (ppm)) from the gas sensor 240, and the infrared radiation profile IR (i.e., heat profile) from the infrared sensor 230. The infrared sensors 230 may be wide-angle sensors and indicate temperature distribution rather than simply a temperature value like the temperature sensor 235. That is, for example, an infrared sensor 230 may indicate that temperature is relatively the highest in the area of a particular cell 210 within the module 220.

Each CMU 215 provides the collected information (V, T, H₂, IR) to the BMS 120. Each CMU 215 may communicate wirelessly with the BMS 120, for example. In alternate embodiments, a cloud-based controller 140 may receive the information from the CMUs 215 in addition to or instead of the BMS 120 within the vehicle 100. As detailed with reference to FIG. 3, a CMU 215, the BMS 120, a cloud-based controller 140, or a combination of these uses the information collected at each CMU 215 to characterize a current state of each module 220 (i.e., to detect the presence of any thermal event) and to perform mitigation of thermal runaway propagation according to one or more embodiments.

Switches S1 and S2 may be used to isolate the battery pack 110 from the additional components 130 and to open the battery. More specifically, the switches S1 and S2 may be contactors that require a relatively lower-power circuit for control and can be connected directly to a high-current load. When the switches S1 and S2 are closed, individual or groups of modules 220 may still be isolated from other modules 220 and the additional components 130 to prevent thermal runaway propagation. The relays R1 through R11 facilitate isolation of the different modules 220, as discussed with reference to FIG. 3 as part of the mitigating actions at block 330.

As FIG. 2 indicates, relays R1 through R8 may be used to isolate corresponding modules 220-1 through 220-8 from the additional components 130 such as accessories. The internal disconnect switch 247 within each module 220 may be a solid state switch or a mechanical connector, for example, and may disconnect the cell groups 210 of the module from the battery pack 110. The relays R1 through R8 facilitate isolating a module 220 that has disconnected cell groups 210 from the rest of the battery pack 110 so that the remaining modules 220 of the battery pack 110 may operate normally.

For example, closing relay R1 isolates the corresponding module 220-1, closing relay R4 isolates the corresponding module 220-4, and so on. Relays R9, R10, and R11 may be closed to isolate pairs or groups of modules 220. For example, closing relay R9 isolates modules 220-4 and 220-5, closing relay R10 isolates modules 220-3, 220-4, 220-5, and 220-6, and closing relay R11 isolates modules 220-2, 220-3, 220-4, 220-5, 220-6, and 220-7 from the additional components 130. A manual service disconnect 260 (e.g., a contactor) may facilitate manual isolation of the entire battery pack 110.

The additional components 130 may include inverters, a direct current (DC)-to-DC converter, and accessories that may be powered by the battery pack 110, for example. As indicated, the switches S1 and S2 may be opened to disconnect the additional components 130 from the modules 220. A pre-charge circuit 250 may be connected between the battery pack 110 and the additional components 130 by keeping the switch S1 open while closing the switch S3. The pre-charge circuit 250 controls current while the battery pack 110 reaches the desired voltage level, before the switches S1 and S2 are closed. The pre-charge circuit 250 protects the switches S1 and S2 from a current spike.

FIG. 3 is a process flow of a method 300 of implementing detection and mitigation of thermal runaway propagation according to one or more embodiments. The processes may be performed by the BMS 120, for example. Alternately or additionally, the processes may be performed by each CMU 215, a cloud-based controller 140, or a combination of one or both of these with the BMS 120. The BMS 120, CMU 215, other controllers 150, and/or cloud-based controller 140 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. A computer-readable storage medium that is understood not to be transitory per se may store instructions that are implemented by a processor of the BMS 120, CMU 215, and/or cloud-based controller 140 to implement the processes of the method 300.

At block 310, obtaining information (V, T, H2, IR) from the sensors 230, 235, 240, 245 refers to the BMS 120 or cloud-based controller 140 obtaining the information from each CMU 215 associated with each module 220 or refers to each CMU 215 obtaining the information from the sensors 230, 235, 240, 245 of the associated module 220.

At block 320, characterizing the current state includes comparing each of the values of voltage V, temperature T, and hydrogen level H₂ against corresponding threshold values and obtaining a dissimilarity score from the infrared radiation profile IR. The dissimilarity score quantifies the variation in the infrared radiation profile IR (e.g., difference between the highest and lowest detected radiation intensity value). An exemplary characterization in the form of levels 0 through 4 is indicated in Table 1. This characterization may be viewed as the detection while the processes at block 330 pertain to the mitigation. When the processes shown in FIG. 3 are performed by each CMU 215, the characterization refers to characterization of each associated module 220. When the processes are performed by the BMS 120 or a cloud-based controller 140, the characterization, at block 320, is done for each module 220 based on information obtained for the module 220.

At block 330, performing an action associated with the current state refers to actions that may mitigate a thermal runaway event. The specific mitigation that is undertaken may be suggested by the characterization at block 320, as indicated in Table 1. The actions may be implemented based on communication to another controller 150 of the vehicle 100. For example, the BMS 120 may characterize the current state and communicate with another controller 150 of the vehicle 100 to control relays R1 through R11 in accordance with the current state.

TABLE 1

Exemplary characterization for detection and corresponding mitigation of a thermal runaway propagation event according to one or more embodiments

| | | |
|---|---|---|
| Characterization | Definition | Mitigation |
| level 0 | all values within thresholds | no action |
| level 1 | H₂ > first H₂ threshold | reduce power |
| level 2 | H₂ > first H₂ threshold | isolate, deplete, perform targeted cooling |
| | V < first V threshold | |
| level 3 | H₂ > third H₂ threshold | isolate module |
| | V < second V threshold | |
| | T > first T threshold | |
| | IR dissimilarity score > | |
| | first dissimilarity threshold | |
| level 4 | H₂ > fourth H₂ threshold | isolate module |
| | V < third V threshold | |
| | T > second T threshold | |
| | IR dissimilarity score > second dissimilarity | |
| | threshold | |

As previously noted, the relays R1 through R11 may be used to perform the mitigating actions corresponding to the different characterizations of the current state of one or more modules 220. When the action performed at block 330 is performed by each CMU 215, the action may be limited (e.g., each CMU 215 may control a subset of the available relays R1 through R11). When the action performed at block 330 is performed by the BMS 120 or a cloud-based controller 140, the actions may involve any of the relays R1 through R11 and the switches S1 through S3.

A characterization, at block 320, as level 0 indicates that all the information (V, T, H₂, IR) indicates normal operation in the relevant module 220. In this case, no mitigating action is taken at block 330. A characterization, at block 320, as level 1 indicates that the hydrogen level H₂ has exceeded a threshold value (e.g., an incipient H₂ venting condition). The corresponding mitigating action taken at block 330 is a reduction in power. That is, the electrical output from the battery pack 110 is reduced by limiting the power output by reducing the load on the battery pack 110 and isolating certain modules 220 via relays R1 through R11.

A characterization, at block 320, as level 2 indicates that the hydrogen level H₂ exceeded a threshold value while the voltage V is below a threshold value in the relevant module 220. At block 330, the corresponding mitigating action is isolation, depletion, and targeting cooling. Isolation of affected modules 220 is accomplished via the relays R1 through R11. Depletion refers to electrically discharging problematic modules 220. Targeting cooling refers to directing more coolant flow through the affected modules 220 to increase the cooling rate. The coolant flow is not shown.

A characterization, at block 320, as level 3 indicates that the hydrogen level H₂, temperature T, and the dissimilarity score obtained from the infrared radiation profile IR have all exceeded associated threshold values while the voltage V is below a threshold value in the relevant module 220. At block 330, the corresponding mitigating action is isolation of the relevant module 220 via closing of the relevant relay R1 through R11.

A characterization, at block 320, as level 4 indicates that the hydrogen level H₂, temperature T, and the dissimilarity score obtained from the infrared radiation profile IR have all exceeded associated threshold values while the voltage V is below a threshold value in the relevant module 220. At block 330, the corresponding mitigating action is isolation of the relevant module 220 via closing of the relevant relay R1 through R11.

As previously noted, the characterization in the form of the levels 0 through 4 and the associated mitigating actions shown in Table 1 are exemplary and do not limit the numbers and types of characterizations and mitigating actions that may be implemented to perform detection and mitigation of thermal runaway propagation in the battery pack 110 according to one or more embodiments.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system in a vehicle, the system comprising:
two or more modules, each of the two or more modules comprising:
battery cell groups, wherein the battery cell groups of the two or more modules provide propulsion power for the vehicle;
a voltage sensor configured to measure a voltage output by the battery cell groups of the module;
a temperature sensor arranged to measure a temperature within the module;
a gas sensor arranged to sense a hydrogen level within the module; and
an infrared sensor positioned to obtain an infrared radiation profile within the module; and
two or more relays, one of the two or more relays being arranged to electrically isolate one of the two or more modules based on one or more of the voltage, the temperature, the hydrogen level, and the infrared radiation profile for the one of the two or more modules.

2. The system according to claim 1, further comprising a cell monitoring unit corresponding with each of the two or more modules.

3. The system according to claim 2, wherein the one of the two or more relays is controlled by the cell monitoring unit corresponding with the one of the two or more modules.

4. The system according to claim 1, further comprising a battery management system configured to obtain the voltage, the temperature, the hydrogen level, and the infrared radiation profile for each of the two or more modules.

5. The system according to claim 4, wherein the one of the two or more relays is controlled by the battery management system.

6. The system according to claim 1, further comprising a cloud-based controller configured to obtain the voltage, the temperature, the hydrogen level, and the infrared radiation profile for each of the two or more modules.

7. The system according to claim 6, wherein the one of the two or more relays is controlled based on one or more algorithms implemented by the cloud-based controller.

8. The system according to claim 1, further comprising a cell monitoring unit corresponding with each of the two or more modules and a battery management system coupled to each cell monitoring unit, wherein each cell monitoring unit obtains the voltage, the temperature, the hydrogen level, and the infrared radiation profile for the corresponding module and provides the voltage, the temperature, the hydrogen level, and the infrared radiation profile to the battery management system, and the battery management system is configured to characterize a current state of each of the two or more modules based on the voltage, the temperature, the hydrogen level, or the infrared radiation profile from each cell monitoring unit.

9. The system according to claim 8, wherein the current state is represented as a level and is determined by comparing each of the voltage, the temperature, and the hydrogen level to predefined threshold values and by comparing a dissimilarity score obtained from the infrared radiation profile with a predefined threshold dissimilarity score.

10. The system according to claim 9, wherein the battery management system is configured to map the current state of each of the two or more modules to an action, wherein the action includes control of the two or more relays.

11. A method of assembling a system in a vehicle, the method comprising:
assembling two or more modules to include:
battery cell groups, wherein the battery cell groups of the two or more modules provide propulsion power for the vehicle;
a voltage sensor configured to measure a voltage output by the battery cell groups of the module;
a temperature sensor arranged to measure a temperature within the module;
a gas sensor arranged to sense a hydrogen level within the module; and
an infrared sensor positioned to obtain an infrared radiation profile within the module; and
arranging two or more relays, one of the two or more relays being arranged to electrically isolate one of the two or more modules based on one or more of the voltage, the temperature, the hydrogen level, and the infrared radiation profile for the one of the two or more modules.

12. The method according to claim 11, further comprising coupling a cell monitoring unit to each of the two or more modules.

13. The method according to claim 12, further comprising configuring the cell monitoring unit corresponding with the one of the two or more modules to control the one of the two or more relays.

14. The method according to claim 11, further comprising arranging a battery management system to obtain the voltage, the temperature, the hydrogen level, and the infrared radiation profile for each of the two or more modules.

15. The method according to claim 14, further comprising configuring the battery management system to control the one of the two or more relays.

16. The method according to claim 11, further comprising establishing communication with a cloud-based controller such that the cloud-based controller obtains the voltage, the temperature, the hydrogen level, and the infrared radiation profile for each of the two or more modules.

17. The method according to claim 16, further comprising implementing one or more algorithms at the cloud-based controller to control the one of the two or more relays.

18. The method according to claim 11, further comprising coupling a cell monitoring unit to each of the two or more modules and to a battery management system, configuring each cell monitoring unit to obtain the voltage, the temperature, the hydrogen level, and the infrared radiation profile for the corresponding module and to provide the voltage, the temperature, the hydrogen level, and the infrared radiation profile to the battery management system, and configuring the battery management system to characterize a current state of each of the two or more modules based on the voltage, the temperature, the hydrogen level, or the infrared radiation profile from each cell monitoring unit.

19. The method according to claim 18, wherein the configuring the battery management system includes the battery management system characterizing the current state as a level comparing each of the voltage, the temperature, and the hydrogen level to predefined threshold values and by comparing a dissimilarity score obtained from the infrared radiation profile with a predefined threshold dissimilarity score.

20. The method according to claim 19, wherein the configuring the battery management system includes the battery management system mapping the current state of each of the two or more modules to an action, wherein the action includes control of the two or more relays.
